(19) United States
(12) Patent Application Publication
(10) Pub. No.: US 2015/0156712 A1
(43) Pub. Date: Jun. 4, 2015

(54) METHOD OF INITIATING COMMUNICATIONS BETWEEN ACCESS POINT AND MOBILE TERMINAL

(71) Applicant: SAMSUNG ELECTRO-MECHANICS CO., LTD., Suwon-Si (KR)

(72) Inventor: Sang Ho CHOI, Suwon-Si (KR)

(73) Assignee: SAMSUNG ELECTRO-MECHANICS CO., LTD., Suwon-Si (KR)

(21) Appl. No.: 14/261,142

(22) Filed: Apr. 24, 2014

(30) Foreign Application Priority Data
Dec. 2, 2013 (KR) 10-2013-0148814

(51) Int. Cl. H04W 48/20

(52) U.S. Cl. CPC H04W 48/20; H04W 40/244

(57) ABSTRACT

There are provided a method of initiating communications between an access point and a mobile terminal. The method of initiating communications of the access point includes: sending a beacon signal to any mobile terminal in a predetermined coverage region; receiving a plurality of request-to-send signals received as responses to the beacon signal during a predetermined time; comparing the amount of a plurality of received request-to-send signals with the amount of predetermined communications possible channels; when the amount of a plurality of request-to-send signals is equal to the number of communications possible channels or less, sending a clear-to-send signal to mobile terminals sending the plurality of request-to-send signals; and determining a mobile terminal with which to initiate communications depending on whether or not at least one further communications initiation signal is received from the mobile terminal receiving the clear-to-send signal.

### CROSS-REFERENCE TO RELATED APPLICATION

This application claims the benefit of Korean Patent Application No. 10-2013-0148814 filed on Dec. 2, 2013, with the Korean Intellectual Property Office, the disclosure of which is incorporated herein by reference.

### BACKGROUND

The present disclosure relates to a method of initiating communications between an access point and a mobile terminal.

In recent times, Wireless Local Area Networks (WLANs) enabling users to access networks or access the Internet through such networks are established worldwide.

As the amount of WLANs has increased and coverage areas thereof are continuously expanded, an amount of interference on a given WLAN may also be increased. Such interference on a WLAN may be caused by several factors, including a separate wireless access point, an electrical current source, and a transmission medium operated while being disposed physically adjacent to each other, and other transmission apparatuses being operated using a common channel and neighboring frequencies. For example, a wireless client apparatus operated on a common channel or an adjacent channel may also cause a decrease in a data transmission rate for one or both WLANs. The interference caused by a separate apparatus operated on the adjacent channel may be referred to as co-channel interference or signal overlap bleeding.

In order to alleviate degradation of the data transmission rate of wireless communications between the wireless access point and the mobile terminal, a technology selecting suitable wireless access point and mobile terminal is demanded.

### RELATED ART DOCUMENT

Korean Patent Laid-Open Publication No. 10-2011-0031135

### SUMMARY

Some embodiments of the present disclosure may provide a method of initiating communications of an access point capable of selecting a mobile terminal to initiate communications therewith by comparing an amount of request-to-send signals, received during a predetermined time, with an amount of communications possible channels.

Some embodiments of the present disclosure may provide a method of initiating communications of a mobile terminal capable of sending a signal indicating that communications are initiated with a further access point when the mobile terminal initiates communications with one access point.

According to some embodiments of the present disclosure, a method of initiating communications of an access point may include: sending a beacon signal to any mobile terminal in a predetermined coverage region; receiving a plurality of request-to-send signals received as responses to the beacon signal during a predetermined time; comparing the amount of a plurality of received request-to-send signals with the number of predetermined communications possible channels; when the amount of the plurality of request-to-send signals is equal to the number of communications possible channels or less, sending clear-to-send signals to mobile terminals sending the plurality of request-to-send signals; and determining a mobile terminal with which to initiate communications depending on whether or not at least one further communications initiation signal is received from the mobile terminal receiving the clear-to-send signal.

In the determining of the mobile terminal with which to initiate communications, when a further communications initiation signal is not received from all mobile terminals receiving the clear-to-send signal, communications may be initiated with the mobile terminals sending the plurality of request-to-send signals.

In the determining of the mobile terminals with which to initiate communications, when at least one further communications initiation signal is received from the mobile terminal receiving the clear-to-send signal, communications may be initiated with all mobile terminals except for the mobile terminal sending the at least one further communications initiation signal among the mobile terminals sending the plurality of request-to-send signals.

According to some embodiments of the present disclosure, a method of initiating communications of an access point may include: sending a beacon signal to a plurality of mobile terminals in a predetermined coverage region; receiving request-to-send signals including the respective channel state information from the plurality of mobile terminals during a predetermined time; comparing the amount of a plurality of received request-to-send signals with the number of predetermined communications possible channels; and when the amount of the plurality of request-to-send signals is larger than the number of communications possible channels, sending a clear-to-send signal, by selecting one combination among combinations of mobile terminals determined by considering the number of request-to-send signals and the number of communications possible channels, according to the channel state information.

The respective combinations of the mobile terminals determined by considering the number of request-to-send signals and the number of communications possible channels may include an amount of mobile terminals corresponding to that of the communications possible channels.

The one combination may be selected by considering channel state information of the mobile terminal belonging to the one combination.

The one combination may be selected by considering strength and orthogonality of a channel state of the mobile terminal belonging to the one combination.

The one combination may have a highest sensitivity index between channels determined by the following Equation among the combinations.

$$β = \frac{{\prod }_{i = 1}^{k} {‖ {h}_{i} ‖}^{2}}{det [ {HH}^{*} ]} , \\ H = {[ \vert {h}_{1}^{T} \vert … \vert {h}_{k}^{T} \vert ]}^{T} \qquad [ Equation ]$$

where β is a sensitivity index between channels, k is the number of communications possible channels, and hₓ, channel state information of an x-th mobile terminal of k mobile terminals belonging to one combination, is a matrix having k rows and one column.

The method may further include determining mobile terminals with which to initiate communications depending on whether or not at least one further communications initiation signal is received from the mobile terminal receiving the clear-to-send signal.

In the determining of the mobile terminals with which to initiate communications, when a further communications initiation signal is not received from all mobile terminals receiving the clear-to-send signal, communications may be initiated with the mobile terminals sending the plurality of request-to-send signals.

The determining of the mobile terminals with which to initiate communications may further include determining whether the mobile terminal sending the at least one further communications initiation signal is included in the respective combinations in a preset rank having a high sensitivity index between the channels among the combinations, when the at least one further communications initiation signal is received from the mobile terminal receiving the clear-to-send signal.

When the mobile terminal sending the at least one further communications initiation signal is included in the respective combinations in the preset rank having the high sensitivity index between the channels among the combinations, communications may be initiated with all mobile terminals except for the mobile terminal sending the at least one further communications initiation signal among mobile terminals belonging to a combination having a highest sensitivity index between the channels.

When all mobile terminals sending the at least one further communications initiation signal are not included in the respective combinations in the preset rank having the high sensitivity index between the channels among the combinations, communications may be initiated with mobile terminals of a combination, not including the mobile terminal sending the at least one further communications initiation signal among the combinations in the preset rank and having the highest sensitivity index between the channels.

According to some embodiments of the present disclosure, a method of initiating communications of a mobile terminal may include: receiving a plurality of beacon signals; sending a plurality of request-to-send signals in response to each of the plurality of beacon signals; receiving at least one clear-to-send signal received as a response to the plurality of request-to-send signals; determining the number of the at least one clear-to-send signals; and when the amount of the at least one clear-to-send signals is plural, initiating communications with an access point sending an initially received clear-to-send signal and sending a further communications initiation signal to an access point subsequently sending the clear-to-send signal.

When the amount of the at least one clear-to-send signals is one, communications may be initiated with an access point sending one clear-to-send signal.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram schematically illustrating a network system according to an exemplary embodiment of the present disclosure;

FIG. 2 is a flowchart illustrating a method of initiating communications in the network system according to an exemplary embodiment of the present disclosure shown in FIG. 1;

FIG. 3 is a diagram schematically illustrating a network system according to another exemplary embodiment of the present disclosure; and

FIGS. 4 through 6 are flow charts illustrating a method of initiating communications in the network system according to an exemplary embodiment of the present disclosure illustrated in FIG. 3.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

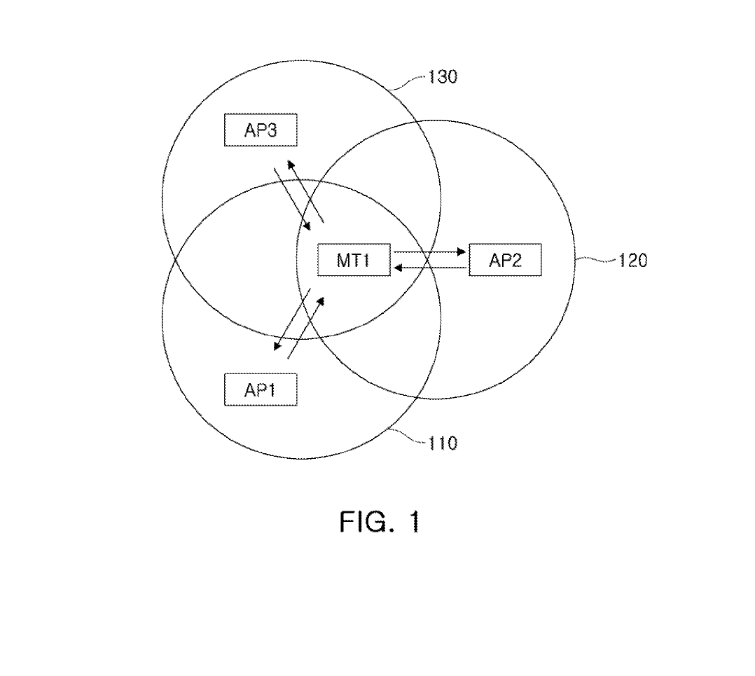

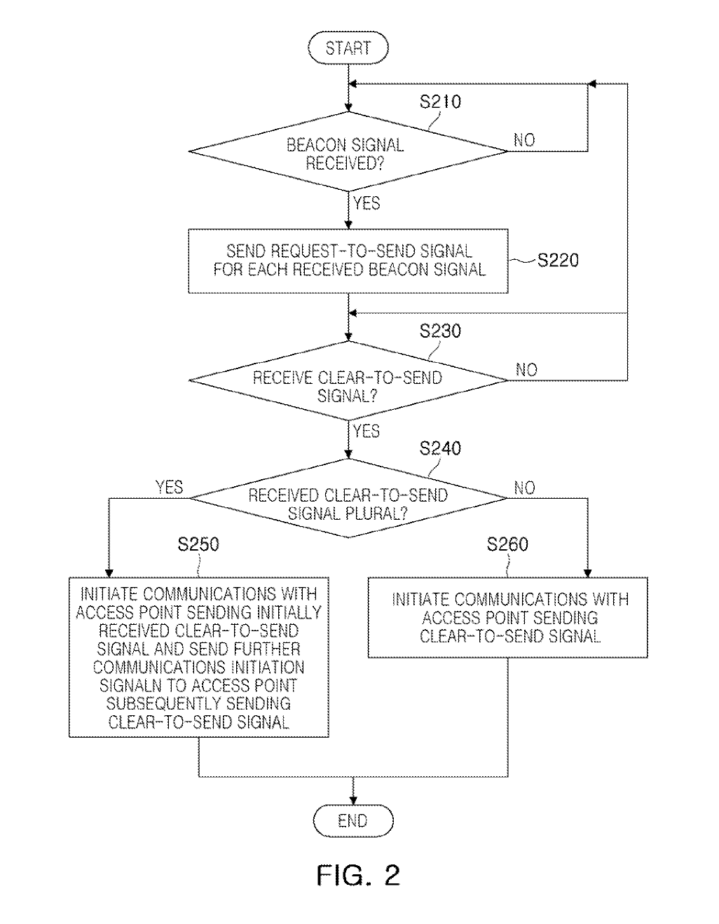

FIG. 1 is a diagram schematically illustrating a network system according to an exemplary embodiment of the present disclosure and FIG. 2 is a flow chart illustrating a method of initiating communications of the network system according to an exemplary embodiment of the present disclosure shown in FIG. 1.

Referring to FIG. 1, a network system according to an exemplary embodiment of the present disclosure may include first to third access points AP1, AP2, and AP3 and a first mobile terminal MT1. In the case in which the first mobile terminal MT1 is located in the respective coverage regions 110, 120, and 130, the first to third access points AP1, AP2, and AP3 may be wirelessly communicated with the first mobile terminal MT1.

The access point in an idle state may send a beacon signal informing that the access point is in the idle state, to any mobile terminal in the coverage region, to initiate communications. The mobile terminal receiving the beacon signal may send a request-to-send signal as a response to the beacon signal.

Hereinafter, a method of initiating communications according to an exemplary embodiment of the present disclosure will be described in detail with reference to FIG. 2.

In the case in which the access point is in the idle state, the access point may send the beacon signal into a respective coverage region and the mobile terminal may determine whether it receives the beacon signal (S210).

When the mobile terminal does not receive the beacon signal, the mobile terminal continuously or periodically determines whether the beacon signal is received. Unlike this, when the mobile terminal receives the beacon signal, the mobile terminal may send the request-to-send signal as the response to the beacon signal, wherein a sending object may be the access point sending the beacon signal (S220). In this case, the request-to-send signal may include channel state information generated by analyzing the beacon signal. The channel state information may indicate information regarding to quality of a channel between the access point and the mobile terminal, wherein the mobile terminal may generate the channel state information by analyzing noise, or the like contained in the beacon signal. In this case, the channel state information may be changed depending on a quality state of the channel between the access point and the mobile terminal.

Describing with reference to FIG. 1, in the case in which the respective first to third access points AP1, AP2, and AP3 send the beacon signal into the respective coverage regions 110, 120, and 130 and the first mobile terminal MT1 receives three beacon signals, the first mobile terminal MT1 may generate the respective channel state information by analyzing the three beacon signals and send the respective channel state information together with the request-to-send signal to the first to third access points AP1, AP2, and AP3. In this case, the mobile terminal MT1 may send the channel state information regarding to the quality of the channel with the first access point AP1 to the first access point AP1 and may send the channel state information regarding to the quality of the channel with the second access point AP2 to the second access point AP2. Likewise, the mobile terminal MT1 may send the channel state information regarding to the quality of the channel with the third access point AP3 to the third access point AP3.

Referring back to FIG. 2, the access point may send clear-to-send signals to mobile terminals selected to be communicated with as a response to the request-to-send signal, and the mobile terminal may determine whether the clear-to-send signal is received (S230). When the clear-to-send signal is not received, the mobile terminal continuously or periodically determines whether the clear-to-send signal or the beacon signal is present.

Unlike this, when the clear-to-send signal is present, it is determined whether the amount of clear-to-send signals is a plural (S240) and when the amount of clear-to-send signals is the plural, the mobile terminal may initiate communications with the access point sending an initially received clear-to-send signal and send a further communications initiation signal to the access point sending a clear-to-send signal which is subsequently received (S250). A further communications initiation signal may indicate a signal representing that the mobile terminal was determined to initiate communications with a further access point.

For example, in the case in which the first mobile terminal MT1 in FIG. 1 initially receives the clear-to-send signal from the first access point AP1, the first mobile terminal MT1 may initiate communications with the first access point AP1 and in the case in which the first mobile terminal MT1 subsequently receives (i.e., next to the first) the clear-to-send signal from the second and third access points AP2 and AP3, the first mobile terminal MT1 may send a further communications initiation signal to the second and third access points AP2 and AP3.

Referring back to FIG. 2, when the mobile terminal does not receive the plurality of clear-to-send signals, but receives only one clear-to-send signal, the mobile terminal may initiate communications with the access point sending the clear-to-send signal (S260).

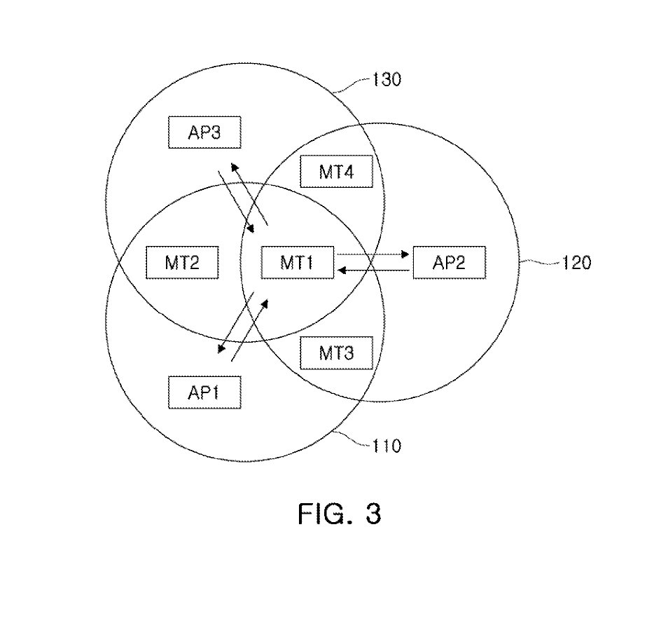

FIG. 3 is a block diagram schematically illustrating a network system according to another exemplary embodiment of the present disclosure. When comparing the network system according an exemplary embodiment of the present disclosure of FIG. 3 with the network system according to an exemplary embodiment of the present disclosure of FIG. 1, it may be appreciated that the network system according an exemplary embodiment of the present disclosure of FIG. 3 further includes second to fourth mobile terminals MT2, MT3, and MT4.

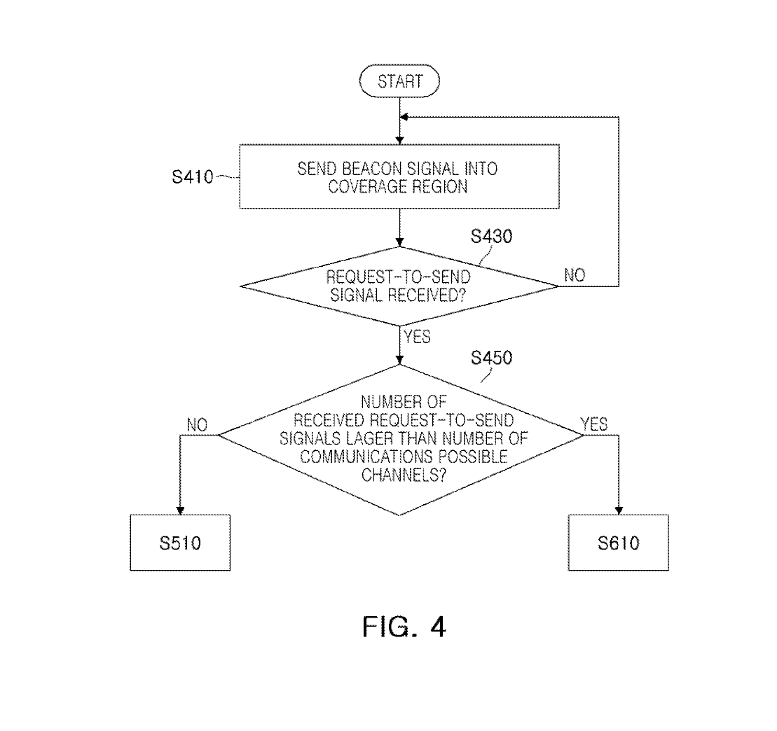

FIGS. 4 through 6 are flowcharts illustrating a method of initiating communications of the network system according to an exemplary embodiment of the present disclosure shown in FIG. 3. Hereinafter, a method of initiating communications according to an exemplary embodiment of the present disclosure will be described in detail with reference to FIGS. 4 through 6.

In the case in which an access point is in an idle state, a beacon signal may be sent into a coverage region of the access point (S410). In this case, the access point sending the beacon signal may determine whether a request-to-send signal is received within a predetermined time (S430).

When the request-to-send signal is not received before the predetermined time is elapsed, the access point may resend the beacon signal into the coverage region. When the request-to-send signal is received within the predetermined time, the access point does not resend a clear-to-send signal to a mobile terminal sending the initially received request-to-send signal, but calculates the amount of request-to-send signals received within the predetermined time and compares the calculated number of request-to-send signals with the amount of communications possible channels of the access point (S450). The amount of communications possible channels means the amount of channels with which the access point may simultaneously communicate, and may be determined depending on the amount of antennas included in the access point according to an example.

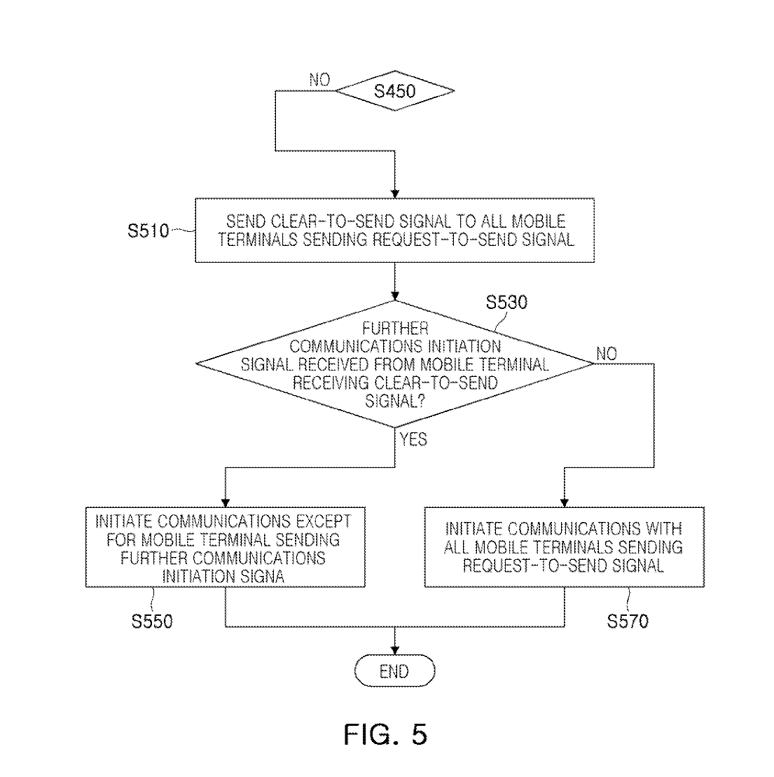

Next, referring to FIG. 5, when the amount of request-to-send signals received within the predetermined time is not larger than the amount of communications possible channels, for example, is equal to or less than the number of communications possible channels, the access point may send the clear-to-send signal to all mobile terminals sending the request-to-send signal (S510). Next, the access point may determine whether a further communications initiation signal is received from the mobile terminal receiving the clear-to-send signal (S530).

For example, referring to FIG. 3, the first access point AP1 sends the clear-to-send signal and before the first to third mobile terminals MT1, MT2, and MT3 receive the clear-to-send signal, the first and second mobile terminals MT1 and MT2 may receive the clear-to-send signal from the third access point AP3 and the first and third mobile terminals MT1 and MT3 may receive the clear-to-send signal from the second access point AP2.

As described above, since the mobile terminal initiates communications with the access point sending the initially received clear-to-send signal and sends a further communications initiation signal to the access point sending the clear-to-send signal which is subsequently received, the first access point AP1 may receive a further communications initiation signal from the first to third mobile terminals MT1, MT2, and MT3.

Referring back to FIG. 5, when the access point receives a further communications initiation signal, the access point may initiate communications with the mobile terminal except for the mobile terminal sending a further communications initiation signal (S550). In this case, when the access point receives a further communications initiation signal from all mobile terminals receiving the clear-to-send signal, the access point may stop the communications.

Unlike this, when the access point does not receive a further communications initiation signal, the access point may initiate communications with all mobile terminals receiving the clear-to-send signal (S570).

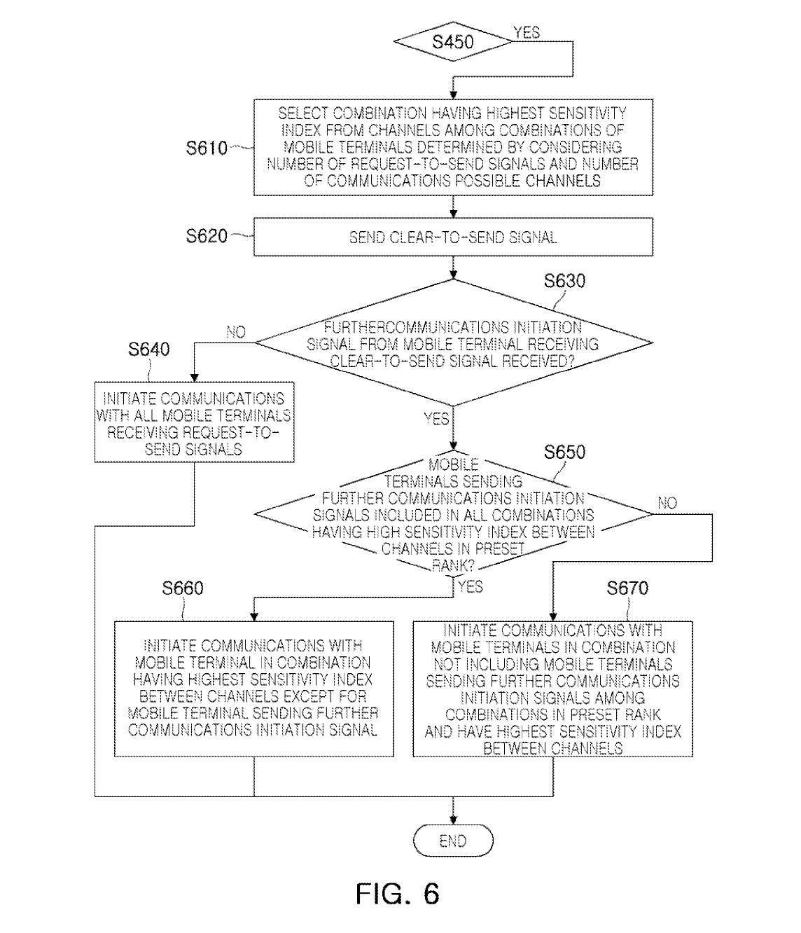

Next, referring to FIG. 6, when the amount of request-to-send signals received within the predetermined time is larger than the amount of communications possible channels, the first access point may select one combination of combinations of the mobile terminals determined by considering the request-to-send signals received and the amount of communications possible channels (S610), and the selected combination may be determined by considering the channel state information of a plurality of mobile terminals belonging to the combination.

In detail, in the case in which the amount of request-to-send signals received is m and the amount of communications possible channels is k, the first access point AP1 takes the k mobile terminals of the m mobile terminals to determine F combinations of mobile terminals. In this case, the amount F of combinations may be calculated by the following Equation 1.

F=ₘCₖ [Equation 1]

In this case, one combination of the F combinations may be selected, wherein the selected combination may be determined by considering the channel state information of the k mobile terminals belonging to the combination. As described above, the request-to-send signal which is sent by the mobile terminal includes the channel state information between the mobile terminal and the access point, wherein the channel state information h may be represented by a matrix having k rows and one column and a better channel state may have a higher level of an element of the channel state information h.

The access point may generate a matrix H which is calculated by the following Equation 2 using the channel state information of the mobile terminals belonging to one combination. Here, h₁ may represent the channel state information of a first mobile terminal of the k mobile terminals included in one combination, and hₖ may similarly represent the channel state information of a k-th mobile terminal. In addition, T may indicate transposing of the matrix.

H=[|h₁^{T}| . . . |hₖ^{T}|]^{T} [Equation 2]

The access point may calculate an sensitivity index β between channels according to the following Equation 3 using the matrix H calculated by the Equation 2 and the channel state information.

$$β = \frac{{\prod }_{i = 1}^{k} {‖ {h}_{i} ‖}^{2}}{det [ {HH}^{*} ]} \qquad [ Equation 3 ]$$

Describing a right hand side of the Equation 3, a numerator may become large as the channel state of the plurality of mobile terminals belonging to one combination becomes good, and a denominator may be calculated by a hermitian product of the matrix H and becomes small as h₁ to hₖ organizing the matrix H are orthogonal to each other, whereby the sensitivity index β between the channels may have a large value.

The access point may calculate the sensitivity index β between the channels for each of the plurality of combinations and send the clear-to-send signal to the plurality of mobile terminals belonging to one combination having the highest sensitivity index β between the channels which is calculated (S620). Next, the access point may determine whether a further communications initiation signal is received from the mobile terminal receiving the clear-to-send signal (S630). When the access point does not receive a further communications initiation signal, the access point may initiate communications with all mobile terminals receiving the clear-to-send signal (S640).

Unlike this, when the access point receives a further communications initiation signal from the mobile terminal receiving the clear-to-send signal, the access point may determine whether the mobile terminal sending a further communications initiation signal is included in the combination within a preset rank having the high sensitivity index β between the channels (S650).

For example, assuming that the preset rank is a fifth rank, since the mobile terminal sending a further communications initiation signal belongs to a first ranked combination, for example, a combination having the highest sensitivity index β between the channels, whether the mobile terminal sending a further communications initiation signal is included in second to fifth ranked combinations is determined. When the mobile terminal sending a further communications initiation signal is included in the second to fifth ranked combinations, the communications may be initiated with mobile terminals except for the mobile terminal sending a further communications initiation signal from the first ranked combination (S650). The preset rank may indicate a rank of a combination capable of assuring communications sensitivity between the channels, and in the case in which the communications are initiated with the mobile terminal belonging to a combination out of the preset rank, since the communications sensitivity may be decreased due to mutual interference, or the like, the communications may be initiated with all mobile terminals except for the mobile terminal sending a further communications initiation signal from the first ranked combination.

Unlike this, in the case in which the mobile terminal sending a further communications initiation signal is not present in the combination within the preset rank, since the communications sensitivity may be secured, the communications may be initiated by selecting a combination having the highest sensitivity index β between the channel among the combinations not including the mobile terminal sending a further communications initiation signal (S670).

According to exemplary embodiments of the present disclosure, the mobile terminal to initiate communications may be efficiently determined by comparing the amount of request-to-send signals received during the predetermined time with the amount of communications possible channels.

Further, the combination of the mobile terminals without having the interference and capable of improving the throughout may be determined from the channel state information included in the request-to-send signal.

While exemplary embodiments are shown and described above, it will be apparent to those skilled in the art that modifications and variations could be made without departing from the spirit and scope of the present disclosure as defined by the appended claims.

What is claimed is:

1. A method of initiating communications of an access point, the method comprising:
sending a beacon signal to any mobile terminal in a predetermined coverage region;
receiving a plurality of request-to-send signals received as responses to the beacon signal during a predetermined time;
comparing the amount of a plurality of received request-to-send signals with the amount of predetermined communications possible channels;
when the amount of a plurality of request-to-send signals is equal to the number of communications possible channels or less, sending a clear-to-send signal to a mobile terminals sending the plurality of request-to-send signals; and
determining a mobile terminals with which to initiate communications depending on whether or not at least one further communications initiation signal is received from the mobile terminal receiving the clear-to-send signal.

2. The method of claim 1, wherein in the determining of the mobile terminals with which to initiate communications, when a further communications initiation signal is not received from all mobile terminals receiving the clear-to-send signal, communications are initiated with the mobile terminals sending the plurality of request-to-send signals.

3. The method of claim 1, wherein in the determining of the mobile terminals with which to initiate communications, when at least one further communications initiation signal is received from the mobile terminal receiving the clear-to-send signal, communications are initiated except for the mobile terminal sending the at least one further communications initiation signal among the mobile terminals sending the plurality of request-to-send signals.

4. A method of initiating communications of an access point, the method comprising:
sending a beacon signal to a plurality of mobile terminals in a predetermined coverage region;
receiving request-to-send signals including channel state information from the plurality of respective mobile terminals during a predetermined time;
comparing the amount of a plurality of received request-to-send signals with the amount of predetermined communications possible channels; and
when the amount of a plurality of request-to-send signals is larger than the amount of communications possible channels, sending a clear-to-send signal, by selecting one combination among combinations of mobile terminals determined by considering the amount of request-to-send signals and the amount of communications possible channels, according to the channel state information.

5. The method of claim 4, wherein the respective combinations of the mobile terminals determined by considering the amount of request-to-send signals and the amount of communications possible channels include an amount of mobile terminals corresponding to that of the communications possible channels.

6. The method of claim 4, wherein the one combination is selected by considering channel state information of the mobile terminal belonging to the one combination.

7. The method of claim 4, wherein the one combination is selected by considering strength and orthogonality of a channel state of the mobile terminal belonging to the one combination.

8. The method of claim 4, wherein the one combination has a highest sensitivity index between channels determined by the following Equation among the combinations.
$$β = \frac{{\prod }_{i = 1}^{k} {‖ {h}_{i} ‖}^{2}}{det [ {HH}^{*} ]} , \\ H = {[ \vert {h}_{1}^{T} \vert … \vert {h}_{k}^{T} \vert ]}^{T} \qquad [ Equation ]$$
where β is a sensitivity index between channels, k is the amount of communications possible channels, and hₓ, which is channel state information of a x-th mobile terminal of k mobile terminals belonging to one combination, is a matrix having k rows and one column.

9. The method of claim 8, further comprising determining a mobile terminal with which to initiate communications depending on whether or not at least one further communications initiation signal is received from the mobile terminal receiving the clear-to-send signal.

10. The method of claim 9, wherein in the determining of the mobile terminal with which to initiate communications, when a further communications initiation signal is not received from all mobile terminals receiving the clear-to-send signal, communications are initiated with the mobile terminals sending the plurality of request-to-send signals.

11. The method of claim 9, wherein the determining of the mobile terminal with which to initiate communications further comprises determining whether the mobile terminal sending the at least one further communications initiation signal is included in the respective combinations in a preset rank having a high sensitivity index between the channels among the combinations, when the at least one further communications initiation signal is received from the mobile terminal receiving the clear-to-send signal.

12. The method of claim 11, wherein when the mobile terminal sending the at least one further communications initiation signal is included in the respective combinations in the preset rank having the high sensitivity index between the channels among the combinations, communications are initiated except for the mobile terminal sending the at least one further communications initiation signal among mobile terminals belonging to a combination having a highest sensitivity index between the channels.

13. The method of claim 11, wherein when all mobile terminals sending the at least one further communications initiation signal are not included in the respective combinations in the preset rank having the high sensitivity index between the channels among the combinations, communications are initiated with mobile terminals of a combination, not including the mobile terminal sending the at least one further communications initiation signal among the combinations in the preset rank and having the highest sensitivity index between the channels.

14. A method of initiating communications of a mobile terminal, the method comprising:
receiving a plurality of beacon signals;
sending a plurality of request-to-send signals in response to each of the plurality of beacon signals;
receiving at least one clear-to-send signal received as a response to the plurality of request-to-send signals;
determining the amount of the at least one clear-to-send signals; and
when the amount of the at least one clear-to-send signal is a plural, initiating communications with an access point sending an initially received clear-to-send signal and sending a further communications initiation signal to an access point subsequently sending the clear-to-send signal.

15. The method of claim 14, wherein when the amount of the at least one clear-to-send signals is one, communications are initiated with an access point sending one clear-to-send signal.
